(19) United States
(12) Patent Application Publication
(10) Pub. No.: US 2024/0013791 A1
(43) Pub. Date: Jan. 11, 2024

(54) SPEAKER RECOGNITION METHOD, SPEAKER RECOGNITION DEVICE, AND SPEAKER RECOGNITION PROGRAM

(71) Applicant: NIPPON TELEGRAPH AND TELEPHONE CORPORATION, Tokyo (JP)

(72) Inventors: Yumiko MURATA, Tokyo (JP); Atsushi ANDO, Tokyo (JP); Takeshi MORI, Tokyo (JP)

(73) Assignee: NIPPON TELEGRAPH AND TELEPHONE CORPORATION, Tokyo (JP)

(21) Appl. No.: 18/038,436

(22) PCT Filed: Nov. 25, 2020
(86) PCT No.: PCT/JP2020/043892

§ 371 Date: May 23, 2023

(51) Int. Cl. G10L 17/06

(52) U.S. Cl. CPC G10L 17/06

(57) ABSTRACT

A speaker vector extraction. unit (15b) extracts a speaker vector representing a feature of a voice of a speaker for each partial section having a predetermined length of a voice signal of an utterance. A learning unit (15c) generates, through learning, a speaker similarity calculation sub-model (14c) for calculating a similarity between a voice signal of an utterance of a speaker registered in advance and a voice signal of an utterance of a verification target speaker by using the speaker vector for each partial section extracted from the voice signal of the utterance of the registered speaker and the speaker vector for each partial section extracted from the voice signal of the utterance of the verification target speaker.

### TECHNICAL FIELD

The present invention relates to a speaker recognition method, a speaker recognition apparatus, and a speaker recognition program.

### BACKGROUND ART

In recent years, a technique for automatically verifying whether or not a short utterance is an utterance of a registered person has been. anticipated. If a speaker can be automatically estimated from a short utterance, for example, a customer can be specified and identified from telephone conversation voice in a contact center. In this case, since it is not necessary to ask a name, an address, a customer ID, and the like, the call time is reduced, and thus operation cost is reduced. In an interaction with a smart speaker or the like, a speaker can be automatically verified by using an utterance log. Then, a family member can be specified from spoken voice, and information presentation or recommendation according to the speaker can be performed.

For such an application, a long utterance of several minutes is used as an utterance for preregistering a speaker (hereinafter, referred to as a registered utterance). On the other hand, as an utterance (hereinafter, referred to as a verification utterance) for verifying a speaker, a short utterance including any phrase for about several seconds is used, and a technique called text-independent speaker verification for short utterances is applied.

In the text-independent speaker verification, features (hereinafter, referred to as a speaker vector) such as an x-vector representing speaker characteristics indicating the speaker himself/herself expressed in voice are extracted from the voice, and a speaker similarity indicating the identity of the speaker is calculated on the basis the similarity between the speaker vectors (refer to Non Patent Literature 1).

Conventionally, an x-vector is extracted by using a neural network (hereinafter, referred to as a speaker vector extraction model). The speaker similarity is quantified by using probabilistic linear discriminant analysis (PLDA), a cosine distance, and the like.

However, in a case where the related art is applied to the text-independent speaker verification for short utterances, a difference in an utterance length between the registered utterance and the verification utterance is expressed in the speaker vector, and it is difficult to correctly quantify the speaker characteristics between the registered utterance and the verification utterance, and thus it is known that the verification accuracy decreases.

Therefore, in evaluating speaker similarity, there have been proposed a technique of reducing variation in speaker similarity due to a difference in utterance length (refer to Non Patent Literature 2) and a technique of using whether or not similarity of a voice signal is high for identity determination (refer to Non Patent Literature 3).

Non Patent Literature 4 discloses an attention mechanism layer in deep learning. Non Patent Literature 5 discloses phoneme bottleneck features and the like.

### CITATION LIST

### Non Patent Literature

### Non Patent Literature 1: D. Snyder, D. Garcia-Romero, G. Sell, D. Povey, and S. Khudanpur, “X-VECTORS: ROBUST DNN EMBEDDINGS FOR SPEAKER RECOGNITION”, ICASSP, 2018, pp. 5329-5333

### Non Patent Literature 2: A. Kanagasundaram, S. Sridharan, G. Sriram, S. Prachi, C. Fookes, “A Study of X-vector Based Speaker Recognition on Short Utterances”, INTERSPEECH, 2019, pp. 2943-2947

### Non Patent Literature 3: Amirhossein Hajavi, Ali Etemad, “A Deep Neural Network for Short-Segment Speaker Recognition”, INTERSPEECH, pp. 2878-2882

Non Patent Literature 4: Ashish Vaswani, Noam Shazeer, Niki Parmar, Jakob Uszkoreit, Llion Jones, Aidan N. Gomez, Lukasz Kaiser, Illia Polosukhin, “Attention Is All You Need”, Neural information Processing Systems (NIPS), 2017, pp. 6000-6010

### Non Patent Literature 5: Jonas Gehring, Yajie Miao, Florian Metze, Alex Waibel, “EXTRACTING DEEP BOTTLENECK FEATURES USING STACKED AUTO-ENCODERS”, ICASSP, 2013, pp. 3377-3381

### SUMMARY OF INVENTION

### Technical Problem

However, in the related art, it is difficult to perform speaker verification in consideration of speaker characteristics expressed in partial sections of the utterance. That is, even if the related art for short utterances is used, it is not possible to consider the speaker characteristics expressed in specific partial sections of the utterance, and the speaker verification accuracy is still low. For example, the speaker characteristics may be strongly expressed in a specific partial section of the utterance such that a characteristic of childness is generated as the /a/ speaking section becomes a nasal sound, or a characteristic of a lispy voice is generated as the tongue surface rises in the speaking section of /s/ or a plosive such as /t/. Although such speaker characteristics strongly appear in a specific partial section, in the related art, since one speaker vector is extracted from the entire utterance section, features of the specific partial section are hardly reflected in the speaker vector, and it is difficult to perform speaker verification in consideration of speaker characteristics expressed in the specific partial section of the utterance.

The present invention has been made in view of the circumstances, and an object of the present invention is to perform speaker verification in consideration of speaker characteristics expressed in partial sections of an utterance.

### Solution to Problem

In order to solve the above problems and achieve the object, according to the present invention, there is provided a speaker recognition method including an extraction step of extracting a speaker vector representing a feature of voice of a speaker for each partial section having a predetermined length of a voice signal of an utterance; and a learning step of generating, through learning, a model for calculating a similarity between a voice signal of an utterance of a speaker registered in advance and a voice signal of an utterance of a verification target speaker by using the speaker vector for each partial section extracted from the voice signal of the utterance of the registered speaker and the speaker vector for each partial section extracted from the voice signal of the utterance of the verification target speaker.

### Advantageous Effects of Invention

According to the present invention, it is possible to perform speaker verification in consideration of speaker characteristics expressed in a partial section of an utterance.

### BRIEF DESCRIPTION OF DRAWINGS

FIG. 1 is a diagram for describing an outline of a speaker recognition apparatus.

FIG. 2 is a schematic diagram illustrating a schematic configuration of the speaker recognition apparatus according to a first embodiment.

FIG. 3 is a diagram for describing a process of the speaker recognition apparatus according to the first embodiment.

FIG. 4 is a diagram for describing a process of the speaker recognition apparatus according to the first embodiment.

FIG. 5 is a flowchart illustrating a speaker recognition process procedure according to the first embodiment.

FIG. 6 is a flowchart illustrating a speaker recognition process procedure according to the first embodiment.

FIG. 7 is a schematic diagram illustrating a schematic configuration of a speaker recognition apparatus according to a second embodiment.

FIG. 8 is a diagram for describing a process of the speaker recognition apparatus according to the second embodiment.

FIG. 9 is a diagram for describing a process of the speaker recognition apparatus according to the second embodiment.

FIG. 10 is a diagram exemplifying a computer that executes a speaker recognition program.

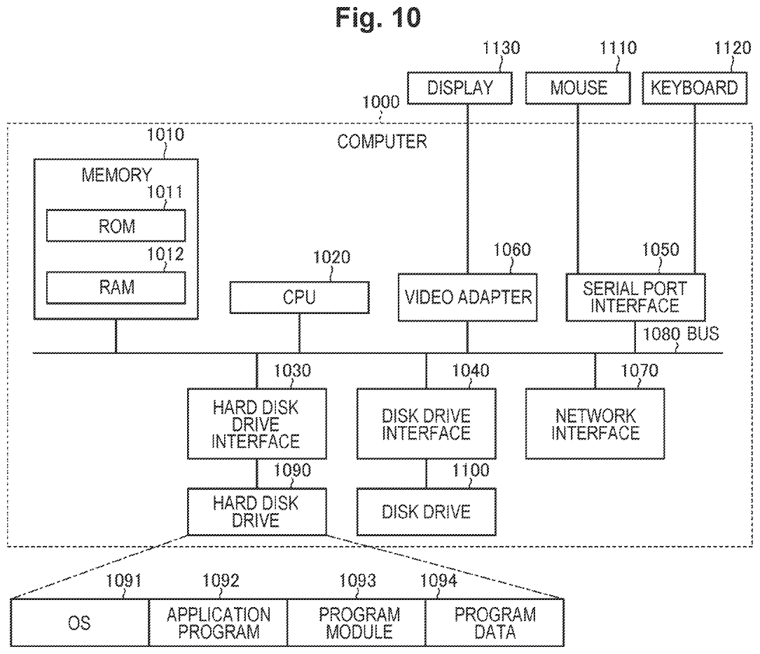

### DESCRIPTION OF EMBODIMENTS

Hereinafter, an embodiment of the present invention will be described in detail with reference to the drawings. The present invention is not limited to this embodiment. In the description of the drawings, the same portions are denoted by the same reference signs.

### Outline of Speaker Recognition Apparatus

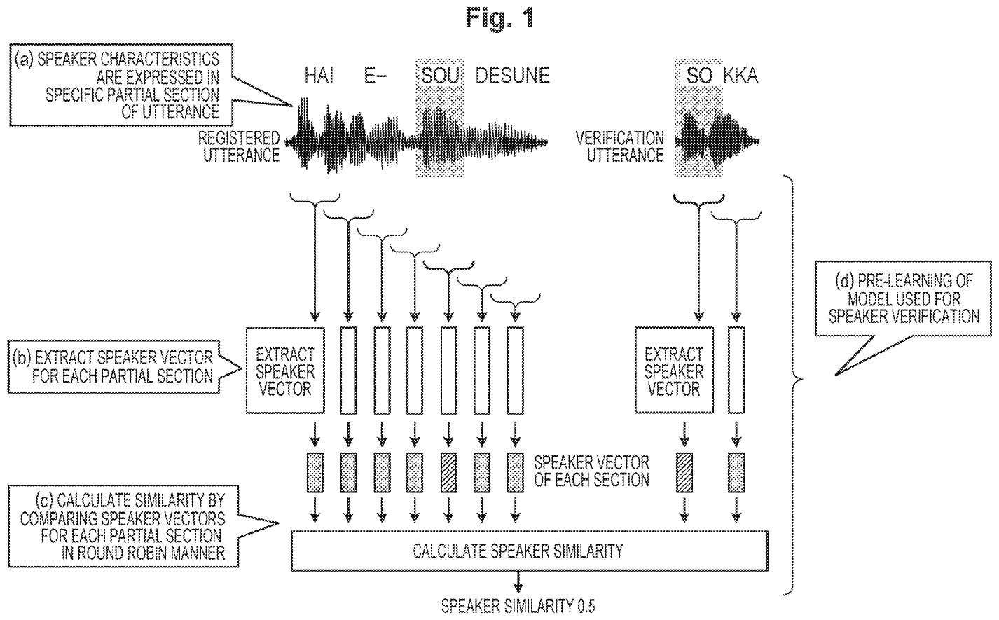

FIG. 1 is a diagram for describing an outline of a speaker recognition apparatus. As illustrated in FIG. 1(a), speaker characteristics are strongly expressed in a specific partial section rather than the entire utterance. In the example illustrated in FIG. 1, for example, the speaker characteristics are expressed in partial sections such as “ha” as a registered utterance that has converted into a nasal sound, “ka” as a verification utterance, “sou” as a registered utterance that is an explosive sound, and “so” as a verification utterance. In this case, it is difficult to say that a speaker vector extracted from the all registered utterances having different section lengths and a speaker vector extracted from the entire verification utterance appropriately express the speaker characteristics as in the conventional case. Therefore, even if such speaker vectors are compared with each other to calculate the similarity, it is difficult to say that the similarity can be used for the speaker similarity.

Therefore, as illustrated in FIG. 1(b), the speaker recognition apparatus of the present embodiment cuts out the registered utterance and the verification utterance in a partial section having a short fixed length such as a width of 1 second and a shift of 0.5 seconds, and extracts a speaker vector for each partial section. As described above, the speaker characteristics expressed in each specific partial section of the utterance can be reflected in the speaker vector. The speaker recognition apparatus generates a model (speaker vector extraction model) for extracting a speaker vector through learning.

As illustrated in FIG. 1(c), the speaker recognition apparatus compares the speaker vector of each partial section of the registered utterance with the speaker vector of each partial section of the verification utterance in a round robin manner to calculate a similarity S. The speaker recognition apparatus generates, through learning, a model (speaker similarity calculation sub-model) for calculating a speaker similarity y with a weighted sum of weights α of the similarity S as the speaker similarity y.

In particular, as illustrated in FIG. 1(d), the speaker recognition apparatus of the present embodiment generates two models such as the speaker vector extraction model and the speaker similarity calculation sub-model through learning as an integrated speaker similarity calculation model. By using the generated speaker similarity calculation model, the speaker recognition apparatus outputs a speaker similarity such as 0.5 for inputs of a registered utterance and a verification utterance. The speaker recognition apparatus estimates speaker match/mismatch each other between the registered utterance and the verification utterance on the basis an output speaker similarity. As described above, the speaker recognition apparatus can perform speaker verification in consideration of speaker characteristics expressed in partial sections of an utterance.

### First Embodiment

### Configuration of Speaker Recognition Apparatus

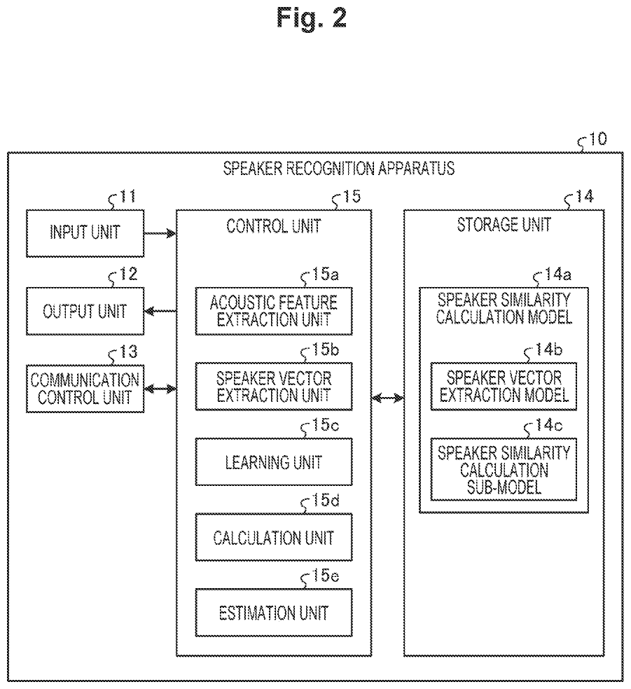

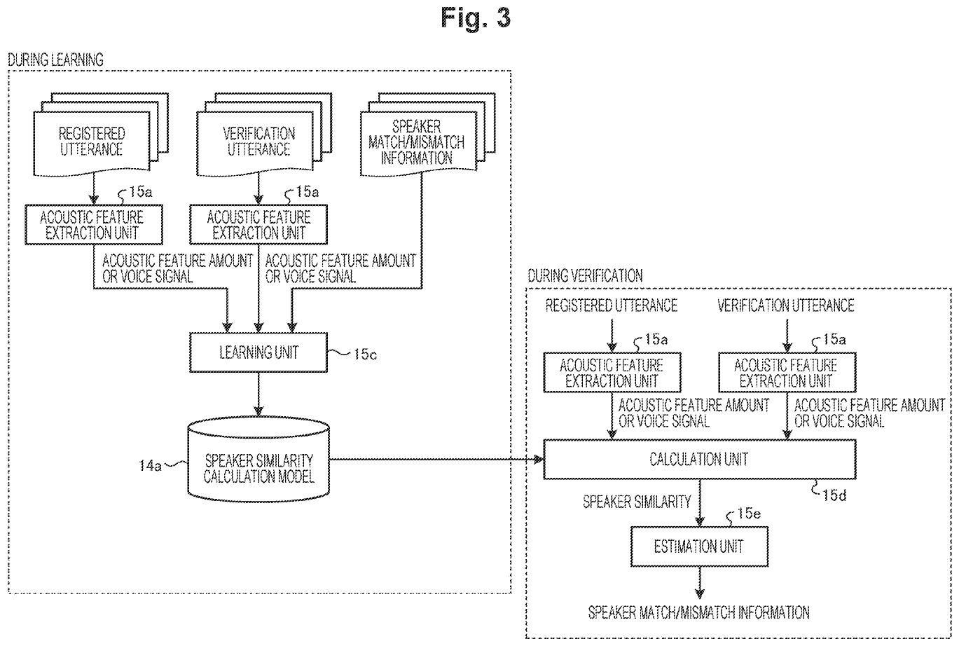

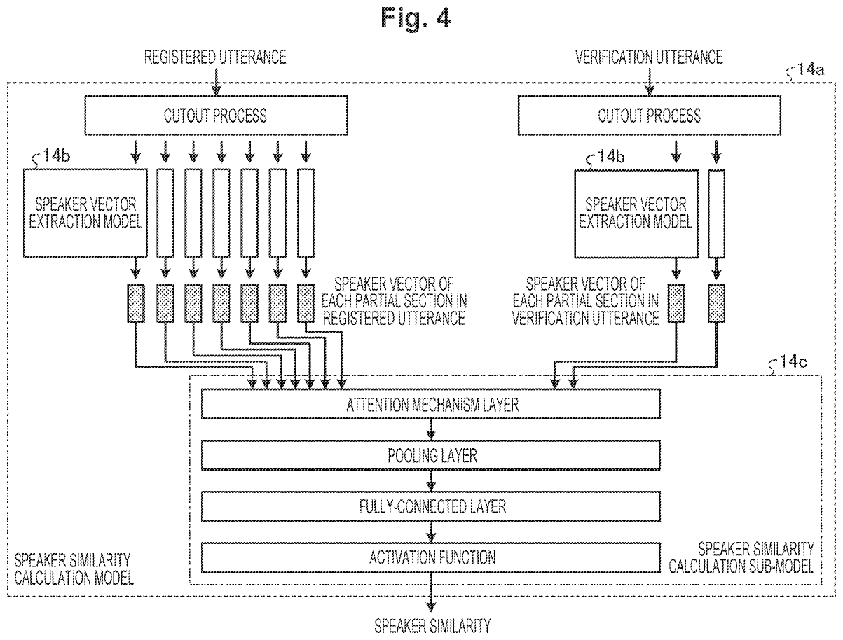

FIG. 2 is a schematic diagram illustrating a schematic configuration of a speaker recognition apparatus according to a first embodiment. FIGS. 3 and 4 are diagrams for describing a process of the speaker recognition apparatus according to the first embodiment. First, as illustrated in FIG. 2, a speaker recognition apparatus 10 is realized by a general-purpose computer such as a personal computer, and includes an input unit 11, an output unit 12, a communication control unit 13, a storage unit 14, and a control unit 15.

The input unit 11 is realized by using an input device such as a keyboard or a mouse, and inputs various types of instruction information such as a process start to the control unit 15 in response to an input operation by an operator. The output unit 12 is realized by a display device such as a liquid crystal display, a printing device such as a printer, an information communication device, or the like.

The communication control unit 13 is realized by a network interface card (NIC) or the like and controls communication between an external device such as a server and the control unit 15 via a network. For example, the communication control unit 13 controls communication between the control unit 15 and a management device or the like that manages a voice signal of an utterance.

The storage unit 14 is realized by a semiconductor memory element such as a random access memory (RAM) or a flash memory, or a storage device such as a hard disk or an optical disc. The storage unit 14 may be configured to communicate with the control unit 15 via the communication control unit 13. In the present embodiment, the storage unit 14 stores, for example, a speaker similarity calculation model 14a used for a speaker recognition process that will be described later. The storage unit 14 may store a voce signal of a registered utterance that will be described later.

The control unit 15 is realized by using a central processing unit (CPU), a network processor (NP) a field programmable gate array (FPGA), or the like, and executes a processing program stored in a memory. Consequently, as illustrated in FIG. 2, the control unit 15 functions as an acoustic feature extraction unit 15a, a speaker vector extraction unit 15b, a learning unit 15c, a calculation unit 15d, and an estimation unit 15e. Each of these functional units may be implemented in different pieces of hardware. For example, the learning unit 15c may be installed as a learning device, and the calculation unit 15d and the estimation unit 15e may be implemented as an estimation device. The control unit 15 may include other functional units.

The acoustic feature extraction unit 15a extracts an acoustic feature of a voice signal of an utterance. For example, the acoustic feature extraction unit 15a receives input of a voice signal of a registered utterance and a voice signal of a verification utterance via the input unit 11 or from a management device or the like that manages a voice signal of an utterance via the communication control unit 13. The acoustic feature extraction unit 15a extracts an acoustic feature for each partial section (short time window) of the voice signal of the utterance, and outputs an acoustic feature sequence in which vectors (speaker vectors) of the acoustic features are arranged in a time series. The acoustic feature is information including, for example, a power spectrum, a logarithmic Mel-filter bank, a Mel Frequency Cepstral Coefficient (MFCC), a fundamental frequency, logarithmic power, and any one or more of a first derivative or a second derivative thereof. Alternatively, the acoustic feature extraction unit 15a may use a voice signal as it is without extracting the acoustic feature sequence.

The speaker vector extraction unit 15b extracts a speaker vector representing a feature of voice of the speaker for each partial section having a predetermined length of the voice signal of the utterance. Specifically, first, the speaker vector extraction unit 15b acquires, from the acoustic feature extraction unit 15a, a voice signal or an acoustic feature sequence of a registered utterance that is an utterance of a speaker registered in advance, and a voice signal or an acoustic feature sequence of a verification utterance that is an utterance of a verification target speaker. In the following description, the “voice signal or acoustic feature sequence” may be simply referred to as a voice signal.

As illustrated in FIG. 4, the speaker vector extraction unit 15b cuts out each of the acquired voice signal of the registered speaker and the voice signal of the verification speaker for each partial section having a short fixed length such as a width of 1 second and a shift of 0.5 seconds, and extracts a speaker vector from each partial section. As illustrated in FIG. 4, the speaker vector extraction unit 15b extracts the speaker vector from each partial section of the voice signal of the utterance by using the speaker vector extraction model 14b.

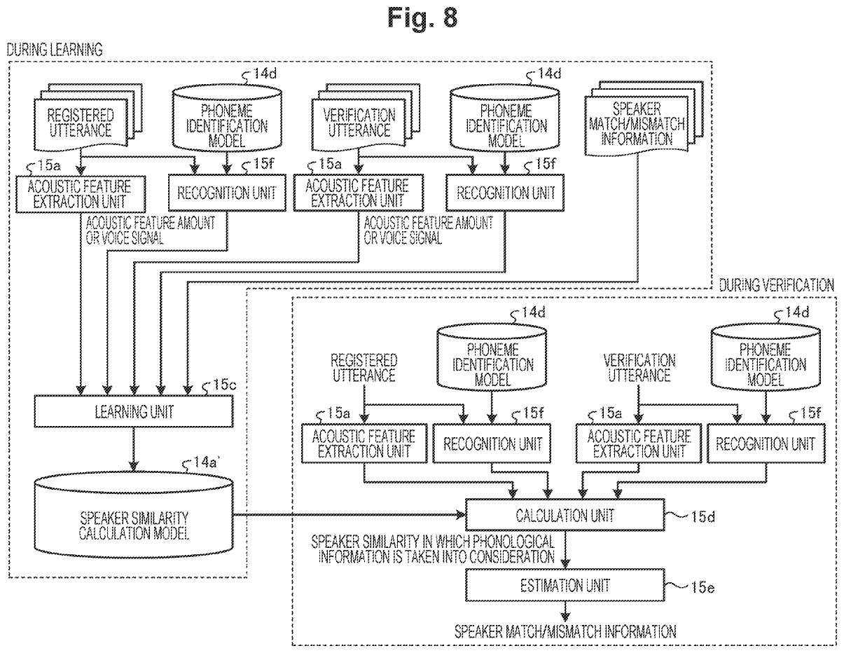

The speaker vector extraction unit 15b may be included in the learning unit 15c and the calculation unit that will be described later. For example, FIG. 3 and FIG. 8 that will be described later illustrate an example in which the learning unit 15c and the calculation unit 15d perform a process of the speaker vector extraction unit 15b. Since the learning unit 15c performs the process of the speaker vector extraction unit 15b, it is possible to integrally learn the speaker vector extraction model 14b and the speaker similarity calculation sub-model 14c as will be described later.

The description returns to FIG. 2. The learning unit 15c uses the speaker vector for each partial section extracted from the voice signal of the utterance of the speaker registered in advance and the speaker vector for each partial section extracted from the voice signal of the utterance of the verification target speaker to generate the speaker similarity calculation sub-model 14c for calculating a similarity between the voice signal of the utterance of the registered speaker and the voice signal of the utterance of the verification target speaker through learning. That is, as illustrated in FIG. 3, the learning unit 15c learns the speaker similarity calculation model 14a including the speaker similarity calculation sub-model 14c by using the speaker vectors of the registered utterance and the verification utterance extracted by the speaker vector extraction unit 15b and the speaker match/mismatch each other information indicating whether the speaker of the registered utterance and the speaker of the verification utterance match each other or mismatch each other.

Specifically, as illustrated in FIG. 4, the learning unit 15c generates The speaker similarity calculation sub-model 14c represented by a weighted sum of the similarities between the speaker vectors of the respective partial sections of the utterance of the registered speaker and the speaker vectors of the respective partial sections of the utterance of the verification target speaker.

That is, the learning unit 15c compares the speaker vector of each partial section of the voice signal of the registered utterance with the speaker vector of each partial section of the voice signal of the verification speaker in a round robin manner to calculate the similarity S. The learning unit 15c generates, through learning, the speaker similarity calculation sub-model 14c that calculates the speaker similarity y that is a weighted sum of the weights α of the respective similarities S, by using the speaker match/mismatch each other information represented by 1/0, for example. Here, the speaker similarity y is expressed. by the following formula (1).

$$\\ \begin{matrix}[ Math . 1 ] & \\ {y}_{enr , tst} = \frac{1}{KN} {\sum }_{n}^{N} {\sum }_{k}^{K} {α}_{k , n} \cdot S ( {v}_{k}^{enr} , {v}_{n}^{tst} ) & ( 1 )\end{matrix}$$

### Here,

y_{enr,tst}: speaker similarity between registered utterance and verification utterance
υₖ^{enr}: speaker vector for verification utterance in cutout partial section (n=1, 2, . . . , N)
υₙ^{tst}: speaker vector for registered utterance in cutout partial section (k=1, 2, . . . , K)
α_{k,n}: similarity weight for set of partial sections
S (•): function for calculating similarity between two speaker vectors

For example, an attention mechanism layer illustrated in FIG. 4 combines the speaker vectors of each partial section of the voice signal of the registered utterance and each partial section of the voice signal of the verification utterance in a round robin manner, calculates the similarity S between the speaker vectors and the weight α of each similarity for each set, and obtains a weighted sum. A pooling layer averages the feature vectors representing the similarity of the registered utterance with respect to each partial section of the verification utterance output from the attention mechanism layer, and a fully-connected layer and an activation function convert the averaged vectors into scalar values such that the speaker similarity y is calculated.

The learning unit 15c generates a speaker vector extraction model 14b used for the speaker vector extraction unit 15b to extract a speaker vector through learning. That is, as illustrated in FIGS. 3 and 4, the learning unit 15c of the present embodiment generates the speaker similarity calculation sub-model 14c and the speaker vector extraction model 14b as an integrated speaker similarity calculation model 14a through learning.

Specifically, the learning unit 15c optimizes the speaker similarity calculation model 14a by using the speaker similarity output from the speaker similarity calculation model 14a and the speaker match/mismatch each other information. That is, the learning unit 15c cuts out a voice signal of the registered utterance and a partial section of the voice signal of the verification utterance, and optimizes the speaker vector extraction model 14b and the speaker similarity calculation sub-model 14c for the speaker vector for each partial section extracted by using the speaker vector extraction model 14b and the speaker similarity calculated by using the speaker similarity calculation sub-model 14c. The learning unit 15c optimizes the speaker vector extraction model 14b and the speaker similarity calculation sub-model 14c such that a speaker similarity output in a case where a speaker of an input registered utterance and a speaker of a verification utterance match each other is large and a speaker similarity output in a case where the speakers do not match each other is small. For example, the learning unit 15c defines a cross entropy error or the like as a loss function, and updates model parameters of the speaker vector extraction model 14b and the speaker similarity calculation sub-model 14c such that the loss function becomes small by using the stochastic gradient descent method.

Consequently, the speaker vector extraction model 14b that can more appropriately extract speaker characteristics for each partial section is generated. For example, the speaker vector extraction model 14b reflecting characteristics that speaking modes of /s/ and /t/ are easily quantified as speaker vectors and the prompting sound is not easily quantified as speaker vectors is generated. The speaker similarity calculation sub-model 14c that can accurately estimate the similarity S of each set including the partial section of the registered utterance and the partial section of the verification utterance and the weight α thereof is generated. For example, the speaker similarity calculation sub-model 14c is generated in which a weight of a similarity between “sou” as a registered utterance and “so” as a verification utterance exemplified in FIG. 1 is high and weights of similarities between the other partial sections are low.

The description returns to FIG. 2. The calculation unit 15d calculates a similarity between the voice signal of the utterance of the speaker registered in advance and the voice signal of the utterance of the verification target speaker by using the generated speaker similarity calculation model 14a. Specifically, the calculation unit inputs the speaker vector of the partial section of the voice signal of the registered utterance and the speaker vector of the partial section of the voice signal of the verification speaker extracted by the speaker vector extraction unit 15b by using the speaker vector extraction model 14b to the speaker similarity calculation sub-model 14c, and outputs a speaker similarity. As illustrated in FIG. 3, the voice signal of the registered utterance used by the calculation unit 15d is not necessarily the same as the voice signal of the registered utterance used by the learning unit 15c, and may be a different voice signal.

The estimation unit 15e estimates whether or not the speakers match each other on the basis of the utterance of the speaker registered in advance and the utterance of the verification target speaker by using the calculated similarity. Specifically, as illustrated in FIG. 3, for example, in a case where the calculated speaker similarity is equal to or more than a predetermined threshold value, the estimation unit 15e estimates that the speakers related to the registered utterance and the verification speaker match each other, and outputs speaker match/mismatch each other information indicating match each other. In a case where the speaker similarity is less than a predetermined threshold value, the estimation unit 15e estimates that the speakers related to the registered utterance and the verification speaker do not match each other, and outputs speaker match/mismatch each other information indicating the mismatch each other.

### Speaker Recognition Process

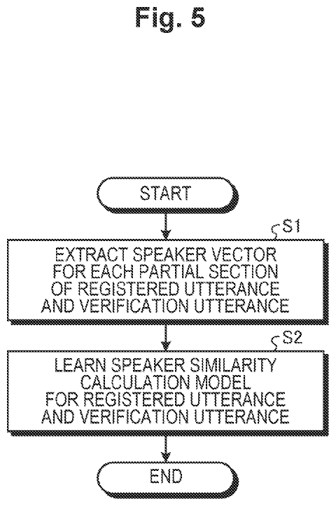

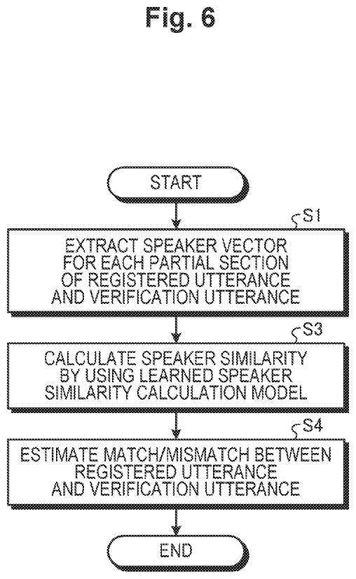

Next, a speaker recognition process performed by the speaker recognition apparatus 10 will be described. FIGS. 5 and 6 are flowcharts illustrating a speaker recognition process procedure. The speaker recognition process of the present embodiment includes a learning process and an estimation process. First, FIG. 5 illustrates a learning process procedure. The flowchart of FIG. 5 is started, for example, at a timing at which there is an input instruction for starting the learning process.

First, the speaker vector extraction unit 15b acquires a voice signal of a registered utterance and a voice signal of a verification utterance from the acoustic feature extraction unit 15a, cuts out the voice signal for each short partial section having a predetermined length, and extracts a speaker vector from each partial section by using the speaker vector extraction model 14b (step S1).

Next, the learning unit 15c generates, through learning, the speaker similarity calculation sub-model 14c that calculates a similarity between the voice signal of the registered utterance and the voice signal of the verification utterance by using the speaker vector for each partial section extracted from the voice signal of the registered utterance and the speaker vector for each partial section extracted from the voice signal of the verification utterance (step S2).

Specifically, the learning unit 15c generates the speaker vector extraction model 14b used for the speaker vector extraction unit 15b to extract the speaker vector through learning. The learning unit 15c compares the speaker vector of each partial section of the voice signal of the registered utterance with the speaker vector of each partial section of the voice signal of the verification speaker in a round robin manner to calculate the similarity S. The learning unit 15c generates, through learning, the speaker similarity calculation sub-model 14c that calculates the speaker similarity y that is a weighted sum of the weights α of the similarities S by using the speaker match/mismatch each other information.

That is, the learning unit 15c uses the speaker similarity calculation sub-model 14c and the speaker vector extraction model 14b as the integrated speaker similarity calculation model 14a, and optimizes the speaker similarity calculation model 14a by using the speaker similarity output from the speaker similarity calculation model 14a and the speaker match/mismatch each other information. Consequently, the series of learning processes are ended.

Next, FIG. 6 illustrates an estimation process procedure. The flowchart of FIG. 6 is started, for example, at a timing at which there is an input instruction for starting the estimation process.

First, the speaker vector extraction unit 15b acquires a voice signal of a registered utterance and a voice signal of a verification utterance from the acoustic feature extraction unit 15a, cuts out the voice signal for each short partial section having a predetermined length, and extracts a speaker vector from each partial section by using the speaker vector extraction model 14b generated through learning (step S1).

Next, the calculation unit 15d calculates a similarity between the voice signal of the registered utterance and the voice signal of the verification utterance by using the generated speaker similarity calculation model 14a (step S3). Specifically, the calculation unit 15d inputs the speaker vector of the partial section of the voice signal of the registered utterance and the speaker vector of the partial section of the voice signal of the verification speaker to the speaker similarity calculation sub-model 14c, and outputs a speaker similarity.

The estimation unit 15e estimates whether or not the speakers related to the registered utterance and the verification utterance of the verification target match each other by using the calculated speaker similarity (step S4), and outputs speaker match/mismatch each other information. Consequently, a series of estimation processes are ended.

### Second Embodiment

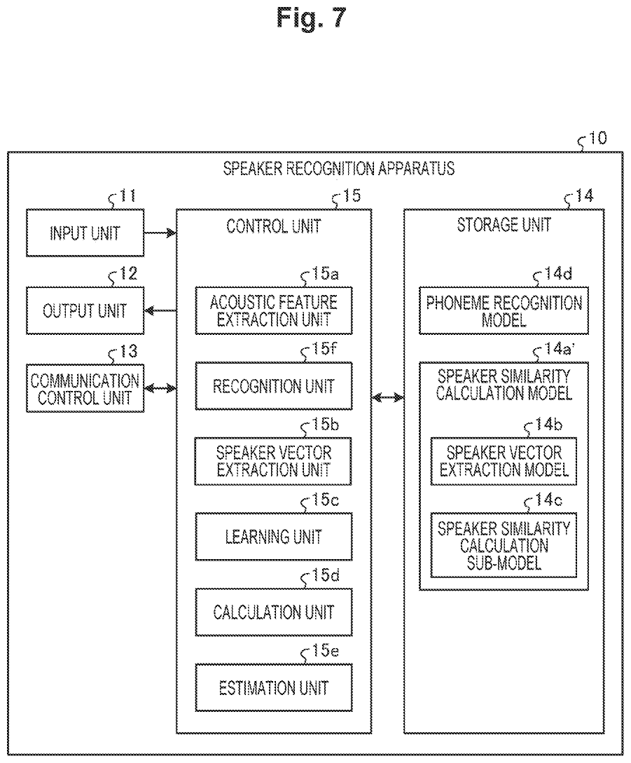

The speaker recognition apparatus 10 is not limited to the above embodiment, and for example, the learning unit may further generate the speaker similarity calculation model 14a through learning by using a phoneme sequence of an utterance. Hereinafter, the speaker recognition apparatus 10 according to the second embodiment will be described with reference to FIGS. 7 to 9. Only differences from the speaker recognition process of the speaker recognition apparatus 10 of the first embodiment will be described, and description of common portions will be omitted.

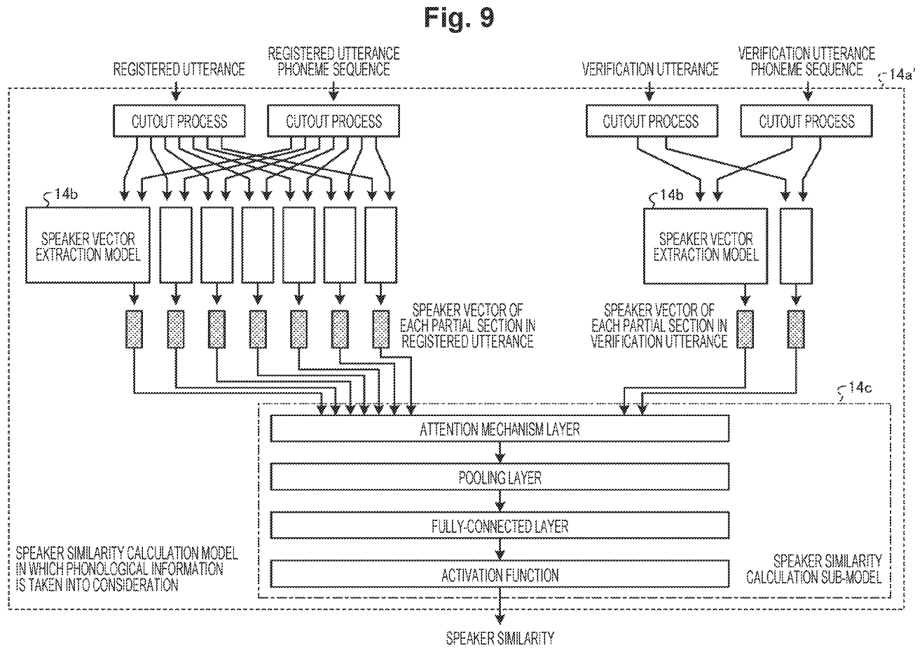

FIG. 7 is a schematic diagram illustrating a schematic configuration of the speaker recognition apparatus according to the second embodiment. FIGS. 8 and 9 are diagrams for describing a process of the speaker recognition apparatus according to the second embodiment. First, as illustrated in FIG. 7, the speaker recognition apparatus 10 of the present embodiment is different from the speaker recognition apparatus 10 of the first embodiment in that a phoneme identification model 14d and a recognition unit 15f are provided.

Specifically, the speaker recognition apparatus 10 of the present embodiment calculates a speaker similarity by further using phonological information of a registered utterance and a verification utterance. Here, the phonological information is, for example, a phoneme sequence of an utterance. Alternatively, the phonological information may be a phoneme posterior probability sequence output as a latent variable, a phoneme bottleneck feature, or the like.

In the speaker recognition apparatus 10 of the present embodiment, the recognition unit 15f outputs a phoneme sequence of an utterance with respect to an input utterance by using the phoneme identification model 14d learned in advance as illustrated in FIG. 8. As illustrated in FIG. 9, the speaker vector extraction unit 15b cuts out a short partial section having a predetermined length such as a width of 1 second or a shift of 0.5 seconds by using the phoneme sequence of the utterance, and extracts a speaker vector for each partial section by using the speaker vector extraction model 14b.

In this case, in addition to the speaker vector of each partial section of the voice signal of the registered utterance and the speaker vector of each partial section of the voice signal of the verification speaker, the learning unit 15c further uses a speaker vector of each partial section of a phoneme sequence of the registered utterance and a speaker vector of each partial section of a voice sequence of the verification utterance. Consequently, the learning unit 15c generates a speaker similarity calculation model 14a′ in consideration of the phonological information through learning.

Similarly to the first embodiment, the learning unit 15c of the present embodiment generates the speaker similarity calculation sub-model 14c and the speaker vector extraction model 14bas an integrated speaker similarity calculation model 14a′ through learning as illustrated in FIGS. 8 and 9.

Specifically, as illustrated in FIG. 8, the speaker vector for each partial section extracted by using the speaker vector extraction model 14b from the voice signal of the registered utterance and the phoneme sequence of the registered utterance, and the voice signal of the verification utterance and the voice sequence of the verification utterance, and the speaker match/mismatch each other information are input to the learning unit 15c. As illustrated in FIG. 9, the learning unit 15c optimizes the speaker vector extraction model 14b and the speaker similarity calculation sub-model 14c by using the speaker similarity calculated by using the speaker similarity calculation sub-model 14c and the speaker match/mismatch each other information.

Consequently, the speaker recognition apparatus 10 can construct the speaker similarity calculation model 14a′ in consideration of the phonological information. Therefore, the speaker recognition apparatus 10 can calculate a speaker similarity with higher accuracy, and can thus estimate whether or not speakers match each other with high accuracy at the time of verification between a registered utterance and a verification utterance.

As described above, in the speaker recognition apparatus 10 of the present embodiment, the speaker vector extraction unit 15b extracts a speaker vector representing a feature of a voice of a speaker for each partial section having a predetermined length of a voice signal of the utterance. The learning unit 15c generates, through learning, the speaker similarity calculation sub-model 14c that calculates a similarity between the voice signal of the registered utterance and the voice signal of the verification utterance by using the speaker vector for each partial section extracted from the registered utterance that is the voice signal of the utterance of the preregistered speaker and the speaker vector for each partial section extracted from the verification utterance that is the voice signal of the utterance of the verification target speaker.

Consequently, it is possible to perform speaker verification in consideration of speaker characteristics expressed in the partial section of the utterance. Therefore, it is possible to estimate whether or not speakers related to the utterance of the registered speaker and the utterance of the verification target speaker match each other with high accuracy.

The learning unit 15c generates the speaker similarity calculation sub-model 14c represented by a weighted sum of similarities between the speaker vectors of the respective partial sections of the registered utterance and the speaker vectors of the respective partial sections of the verification utterance. Consequently, it is possible to calculate a speaker similarity with high accuracy.

The learning unit 15c generates a speaker vector extraction model 14b used for the speaker vector extraction unit 15b to extract a speaker vector through learning. That is, the learning unit 15c generates the speaker similarity calculation sub-model 14c and the speaker vector extraction model 14b as an integrated speaker similarity calculation model 14a through learning. Consequently, it is possible to efficiently generate the speaker vector extraction model 14b that can more appropriately extract the speaker characteristics for each partial section and the speaker similarity calculation sub-model 14c that can accurately estimate the similarity S and the weight α of each set including the partial section of the registered utterance and the partial section of the verification utterance.

In the speaker recognition apparatus 10, the calculation unit 15d calculates a speaker similarity between the voice signal of the utterance of the speaker registered in advance and the voice signal of the verification utterance of the verification target by using the generated speaker similarity calculation model 14a. The estimation unit 15e estimates whether or not speakers related to the utterance of the registered speaker and the utterance of the verification target speaker match each other by using the calculated speaker similarity. Consequently, it is possible to estimate whether or not speakers related to the utterance of the registered speaker and the utterance of the verification target speaker match each other with high accuracy.

The learning unit 15c further uses the phoneme sequence of the utterance to generate a speaker similarity calculation sub-model 14c′ through learning. Consequently, the speaker recognition apparatus 10 can calculate the speaker similarity with higher accuracy, and can thus estimate whether or not the speakers match each other with higher accuracy at the time of verification between the registered utterance and the verification utterance.

### Program

It is also possible to create a program in which the process executed by the speaker recognition apparatus 10 according to the above embodiment is described in a language executable by a computer. As an embodiment, the speaker recognition apparatus 10 can be implemented by installing a speaker recognition program for executing the speaker recognition process as package software or online software in a desired computer. For example, an information processing apparatus can be caused to function as the speaker recognition apparatus 10 by causing the information processing apparatus to execute the speaker recognition program described above. Moreover, the information processing apparatus also includes a mobile communication terminal such as a smartphone, a mobile phone, and a personal handyphone system (PHS), a slate terminal such as a personal digital assistant (PDA), and the like. The function of the speaker recognition apparatus 10 may be implemented in a cloud server.

FIG. 12 is a diagram illustrating an example of a computer that executes the speaker recognition program. A computer 1000 includes, for example, a memory 1010, a CPU 1020, a hard disk drive interface 1030, a disk drive interface 1040, a serial port interface 1050, a video adapter 1060, and a network interface 1070. These units are connected. to each other via a bus 1080.

The memory 1010 includes a read only memory (ROM) 1011 and a RAE 1012. The ROM 1011 stores, for example, a boot program such as a basic input output system (BIOS). The hard disk drive interface 1030 is connected to a hard disk drive 1031. The disk drive interface 1040 is connected to a disk drive 1041. For example, a removable storage medium such as a magnetic disk or an optical disc is inserted into the disk drive 1041. The serial port interface 1050 is connected to, for example, a mouse 1051 and a keyboard 1052. The video adapter 1060 is connected for example, a display 1061.

Here, the hard disk drive 1031 stores, for example, an OS 1091, an application program 1092, a program module 1093, and program data 1094. All of the information described in the above embodiment is stored in the hard disk drive 1031 or the memory 1010, for example.

The speaker recognition program is stored in the hard disk drive 1031 as a program module 1093 in which a command executed by the computer 1000 is described, for example. Specifically, the program module 1093 in which each process executed by the speaker recognition apparatus 10 described in the above embodiment is described is stored in the hard disk drive 1031.

Data used for information processing by the speaker recognition program is stored in, for example, the hard disk drive 1031 as the program data 1094. The CPU 1020 reads, into the RAM 1012, the program module 1093 and the program data 1094 stored in the hard disk drive 1031 as needed and executes each procedure described above.

The program module 1093 and the program data 1094 related to the speaker recognition program are not limited to being stored in the hard disk drive 1031, and may be stored in, for example, a removable storage medium and read by the CPU 1020 via the disk drive 1041 or the like. Alternatively, the program module 1093 and the program data 1094 related to the speaker recognition program may be stored in another computer connected via a network such as a local area network (LAN) or a wide area network (WAN) and read by the CPU 1020 via the network interface 1070.

Although the embodiments to which the invention made by the present inventor is applied have been described above, the present invention is not limited by the description and the drawings constituting a part of the disclosure of the present invention according to the present embodiments. In other words, other embodiments, examples, operation techniques, and the like made by those skilled in the art and the like on the basis of the present embodiments are all included is the scope of the present invention.

### REFERENCE SIGNS LIST

10 Speaker recognition apparatus
11 Input unit
12 Output unit
13 Communication control unit
14 Storage unit
14a Speaker similarity calculation model
14b Speaker vector extraction model
14c Speaker similarity calculation sub-model
14d Phoneme identification model
15 Control unit
15a Acoustic feature extraction unit
15b Speaker vector extraction unit
15c Learning unit
15d Calculation unit
15e Estimation unit
15f Recognition unit

1. A speaker recognition method executed by a speaker recognition apparatus, the speaker recognition method comprising:
extracting a speaker vector, wherein the speaker vector represents a feature of voice of a speaker for each partial section of a plurality of partial sections of a voice, and the each partial section has a predetermined length of the voice signal of an utterance; and
generating, through learning, a similarity model, wherein the similarity model calculates a similarity between a voice signal of an utterance of a speaker registered in advance and a voice signal of an utterance of a verification target speaker, wherein the learning uses the speaker vector for each partial section extracted from the voice signal of the utterance of the registered speaker and the speaker vector for each partial section extracted from the voice signal of the utterance of the verification target speaker.

2. The speaker recognition method according to claim 1, wherein
the learning further comprises generating the similarity model represented by a weighted sum of similarities between speaker vectors of the respective partial sections of the utterance of the registered speaker and speaker vectors of the respective partial sections of the utterance of the verification target speaker.

3. The speaker recognition method according to claim 1, wherein
the learning further comprises generating, through learning, an extraction model, wherein the extraction model extracts, based on the plurality of partial sections of the voice the speaker vector.

4. The speaker recognition method according to claim 1, further comprising:
calculating the similarity between the voice signal of the utterance of the speaker registered in advance and the voice signal of the verification target utterance by using the generated similarity model; and
estimating whether or not speakers related to the utterance of the registered speaker and the utterance of the verification target speaker match each other by using the calculated similarity.

5. The speaker recognition method according to claim 1, wherein
the learning further comprises generating the similarity model through learning by further using a phoneme sequence of the utterance.

6. A speaker recognition apparatus comprising a processor configured to execute operations comprising:
extracting a speaker vector, wherein the speaker vector represents a feature of voice of a speaker for each partial section of a plurality of partial sections of a voice, and the each partial section having a predetermined length of a voice signal of an utterance; and
generating, through learning, a similarity model, wherein the similarity model calculates a similarity between a voice signal of an utterance of a speaker registered in advance and a voice signal of an utterance of a verification target speaker, wherein the learning uses the speaker vector for each partial section extracted from the voice signal of the utterance of the registered speaker and the speaker vector for each partial section extracted from the voice signal of the utterance of the verification target speaker.

7. A computer-readable non-transitory recording medium storing computer-executable program instructions that when executed by a processor cause a computer system to execute operations comprising:
extracting a speaker vector, wherein the speaker vector represents a feature of voice of a speaker for each partial section of a plurality of partial sections of a voice, and the each partial section has a predetermined length of a voice signal of an utterance; and
generating, through learning, a similarity model, wherein the similarity model calculates a similarity between a voice signal of an utterance of a speaker registered in advance and a voice signal of an utterance of a verification target speaker, wherein the learning uses the speaker vector for each partial section extracted from the voice signal of the utterance of the registered speaker and the speaker vector for each partial section extracted from the voice signal of the utterance of the verification target speaker.

8. The speaker recognition method according to claim 1, wherein the feature of voice of a speaker includes at least one of: a power spectrum, a logarithmic Mel-filter bank, a Mel Frequency Cepstral Coefficient (MFCC), a fundamental frequency, or logarithmic power.

9. The speaker recognition method according to claim 1, wherein the similarity between a first voice signal of an utterance of a speaker registered in advance and a second voice signal of an utterance of the verification target speaker is based on phonological information associated with the first voice signal and the second voice signal.

10. The speaker recognition apparatus according to claim 6, wherein
the learning further comprises generating the similarity model represented by a weighted sum of similarities between speaker vectors of the respective partial sections of the utterance of the registered speaker and speaker vectors of the respective partial sections of the utterance of the verification target speaker.

11. The speaker recognition apparatus according to claim 6, wherein
the learning further comprises generating, through learning, an extraction model, wherein the extraction model extracts, based on the plurality of partial sections of the voice the speaker vector.

12. The speaker recognition apparatus according to claim 6, the processor further configured to execute operations comprising:
calculating the similarity between the voice signal of the utterance of the speaker registered in advance and the voice signal of the verification target utterance by using the generated similarity model; and
estimating whether or not speakers related to the utterance of the registered speaker and the utterance of the verification target speaker match each other by using the calculated similarity.

13. The speaker recognition apparatus according to claim 6, wherein
the learning further comprises generating the similarity model through learning by further using a phoneme sequence of the utterance.

14. The speaker recognition apparatus according to claim 6, wherein the feature of voice of a speaker includes at least one of: a power spectrum, a logarithmic Mel-filter bank, a Mel Frequency Cepstral Coefficient (MFCC), a fundamental frequency, or logarithmic power.

15. The speaker recognition apparatus according to claim 6, wherein the similarity between a first voice signal of an utterance of a speaker registered in advance and a second voice signal of an utterance of the verification target speaker is based on phonological information associated with the first voice signal and the second voice signal.

16. The computer-readable non-transitory recording medium according to claim 7, wherein
the learning further comprises generating the similarity model represented by a weighted sum of similarities between speaker vectors of the respective partial sections of the utterance of the registered speaker and speaker vectors of the respective partial sections of the utterance of the verification target speaker.

17. The computer-readable non-transitory recording medium according to claim 7, wherein
the learning further comprises generating, through learning, an extraction model, wherein the extraction model extracts, based on the plurality of partial sections of the voice the speaker vector.

18. The computer-readable non-transitory recording medium according to claim 7, the computer-executable program instructions when executed further causing the computer system to execute operations comprising:
calculating the similarity between the voice signal of the utterance of the speaker registered in advance and the voice signal of the verification target utterance by using the generated similarity model; and
estimating whether or not speakers related to the utterance of the registered speaker and the utterance of the verification target speaker match each other by using the calculated similarity.

19. The computer-readable non-transitory recording medium according to claim 7, wherein
the learning further comprises generating the similarity model through learning by further using a phoneme sequence of the utterance.

20. The computer-readable non-transitory recording medium according to claim 7, wherein
the feature of voice of a speaker includes at least one of: a power spectrum, a logarithmic Mel-filter bank, a Mel Frequency Cepstral Coefficient (MFCC), a fundamental frequency, or logarithmic power.
